(19) United States
(12) Patent Application Publication
(10) Pub. No.: US 2025/0031007 A1
(43) Pub. Date: Jan. 23, 2025

(54) ACOUSTIC PROCESSING METHOD, RECORDING MEDIUM, AND ACOUSTIC PROCESSING SYSTEM

(71) Applicant: Panasonic Intellectual Property Corporation of America, Torrance, CA (US)

(72) Inventors: Kota NAKAHASHI, Osaka (JP); Seigo ENOMOTO, Kyoto (JP); Hikaru USAMI, Osaka (JP); Mariko YAMADA, Hyogo (JP); Hiroyuki EHARA, Kanagawa (JP); Ko MIZUNO, Osaka (JP); Tomokazu ISHIKAWA, Osaka (JP)

(21) Appl. No.: 18/908,060

(22) Filed: Oct. 7, 2024

Related U.S. Application Data
(63) Continuation of application No. PCT/JP2023/014064, filed on Apr. 5, 2023.
(60) Provisional application No. 63/330,925, filed on Apr. 14, 2022.

(30) Foreign Application Priority Data
Jan. 30, 2023 (JP) 2023-012030

(51) Int. Cl. H04S 7/00

(52) U.S. Cl. CPC H04S 7/304; H04S 2400/11

(57) ABSTRACT

An acoustic processing method includes: obtaining (i) sound information related to a sound including a predetermined sound and (ii) metadata including information related to a space in which the predetermined sound is reproduced; performing, based on the sound information and the metadata, acoustic processing of generating a sound signal expressing a sound including an early reflection that reaches a user after a direct sound that reaches the user directly from a sound source object; and outputting an output sound signal including the sound signal. The acoustic processing includes: determining parameters for generating the early reflection, the parameters including a position, in the space, of a virtual sound source object that generates the early reflection; and generating the early reflection based on the parameters determined. The parameters include at least a parameter that varies over time according to a predetermined condition.

### CROSS REFERENCE TO RELATED APPLICATIONS

This is a continuation application of PCT International Application No. PCT/JP2023/014064 filed on Apr. 5, 2023, designating the United States of America, which is based on and claims priority of U.S. Provisional Patent Application No. 63/330,925 filed on Apr. 14, 2022, and Japanese Patent Application No. 2023-012030 filed on Jan. 30, 2023. The entire disclosures of the above-identified applications, including the specifications, drawings and claims are incorporated herein by reference in their entirety.

### FIELD

The present disclosure relates to an acoustic processing method, a recording medium, and an acoustic processing system for realizing stereoscopic acoustics in a space.

### BACKGROUND

PTL 1 discloses a sound environment simulation experience device that reproduces a sound environment in a desired space without using an actual room or model.

### CITATION LIST

### Patent Literature

PTL 1: Japanese Patent No. 3152818

### SUMMARY

### Technical Problem

An object of the present disclosure is to provide an acoustic processing method and the like that make it easy to reproduce a sound unlikely to impart a sense of unnaturalness on a user while reducing a computational amount.

### Solution to Problem

In an acoustic processing method according to one aspect of the present disclosure, (i) sound information related to a sound including a predetermined sound and (ii) metadata including information related to a space in which the predetermined sound is reproduced are obtained. In the acoustic processing method, based on the sound information and the metadata, acoustic processing of generating a sound signal expressing a sound including an early reflection that reaches a user after a direct sound that reaches the user directly from a sound source object is performed. In the acoustic processing method, an output sound signal including the sound signal is output. The acoustic processing includes: determining parameters for generating the early reflection, the parameters including a position, in the space, of a virtual sound source object that generates the early reflection; and generating the early reflection based on the parameters determined. The parameters include at least a parameter that varies over time according to a predetermined condition.

A recording medium according to one aspect of the present disclosure is a non-transitory computer-readable recording medium having recorded thereon a program for causing a computer to execute the above-described acoustic processing method.

An acoustic processing system according to one aspect of the present disclosure includes an obtainer, an acoustic processor, and an outputter. The obtainer obtains (i) sound information related to a sound including a predetermined sound and (ii) metadata including information related to a space in which the predetermined sound is reproduced. The acoustic processor performs, based on the sound information and the metadata, acoustic processing of generating a sound signal expressing a sound including an early reflection that reaches a user after a direct sound that reaches the user directly from a sound source object. The outputter outputs an output sound signal including the sound signal. The acoustic processor includes a parameter determiner and an early reflection generation processor. The parameter determiner determines parameters for generating the early reflection, the parameters including a position, in the space, of a virtual sound source object that generates the early reflection. The early reflection generation processor generates the early reflection based on the parameters determined. The parameters include at least a parameter that varies over time according to a predetermined condition.

Note that these comprehensive or specific aspects may be realized by a system, a device, a method, an integrated circuit, a computer program, or a non-transitory computer-readable recording medium such as a CD-ROM, or may be implemented by any desired combination of systems, devices, methods, integrated circuits, computer programs, and recording media.

### Advantageous Effects

The present disclosure has an advantage in that it is easy to reproduce a sound unlikely to impart a sense of unnaturalness on a user while reducing a computational amount.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating a use case for an acoustic reproduction device according to an embodiment.

FIG. 2 is a block diagram illustrating the functional configuration of the acoustic reproduction device according to the embodiment.

FIG. 3 is a block diagram illustrating the functional configuration of the acoustic processing system according to the embodiment in more detail.

FIG. 4 is an explanatory diagram illustrating variations over time in early reflection parameters.

FIG. 5 is a flowchart illustrating basic operations by the acoustic processing system according to the embodiment.

FIG. 6 is a block diagram illustrating the functional configuration of Example 1 of the acoustic processing system according to the embodiment.

FIG. 7 is a flowchart illustrating operations performed in Example 1 of the acoustic processing system according to the embodiment.

FIG. 8 is an explanatory diagram illustrating operations performed in Example 2 of the acoustic processing system according to the embodiment.

FIG. 9 is a flowchart illustrating operations performed in Example 2 of the acoustic processing system according to the embodiment.

### DESCRIPTION OF EMBODIMENTS

Techniques related to acoustic reproduction have been known which cause a user to perceive stereoscopic sound by controlling the position at which the user senses a sound image, which is a sound source object, in a virtual three-dimensional space (sometimes called a “three-dimensional sound field” hereinafter). By localizing the sound image at a predetermined position in the virtual three-dimensional space, the user can perceive this sound as if it were arriving from a direction parallel to the straight line connecting the predetermined position and the user (i.e., a predetermined direction). To localize a sound image at a predetermined position in a virtual three-dimensional space in such a manner, it is necessary, for example, to perform calculation processing on collected sound which produces a difference in times at which the sound arrives between the two ears, a difference in the levels (or sound pressures) of the sounds between the two ears, and the like such that the sound is perceived as being a stereoscopic sound.

Technologies related to virtual reality (VR) or augmented reality (AR) are being developed extensively in recent years. For example, in virtual reality, the position of a virtual space does not follow the movement of the user, with the focus being placed on enabling the user to feel as if they were actually moving within the virtual space. In virtual reality or augmented reality technology, particular attempts are being made to further enhance the sense of realism by combining auditory elements with the visual elements. Enhancing the localization of the sound image as described above is particularly useful to make sounds seem as if they are being heard from outside the user's head, to improve the sense of auditory immersion.

Incidentally, various types of acoustic processing are useful for implementing stereoscopic acoustics in a three-dimensional sound field. Here, “acoustic processing” refers to processing that generates sound, other than direct sound moving from a sound source object to a user, in the three-dimensional sound field.

Acoustic processing can include, for example, processing that generates an early reflection. An “early reflection” is a reflected sound that reaches the user after at least one reflection at a relatively early stage after the direct sound from the sound source object reaches the user (e.g., several tens of ms after the time at which the direct sound arrives). There is a need to reduce the amount of computation required to generate the early reflection when reproducing content in virtual reality or augmented reality.

Here, a method that determines any one point in the three-dimensional sound field as the position of a virtual sound source object that produces the early reflection can be given as an example of a method for generating an early reflection with a relatively low computational amount. That is, in this method, the early reflection is represented as a direct sound reaching the user from the virtual sound source object.

However, the following issues can arise when using this method. In a real space, when reflected sound from a sound source object reaches a user via a reflection point, the sound waves moving from the reflection point toward the user fluctuate in direction or sound pressure. As such, the exact same sound waves do not continue to reach the user from the reflection point, even if the reflection point remains at the same position. However, if the above method is used, the same reflected sound will continue to reach the user from the reflection point (the position of the virtual sound source object), which may feel unnatural to the user.

Although it is conceivable to generate the early reflection while simulating the fluctuation of sound waves from the reflection point in the real space, there is a problem in that doing so requires a high amount of computation, and the goal of reducing the amount of computation required to generate the early reflection cannot be achieved.

In view of the foregoing, an object of the present disclosure is to provide an acoustic processing method and the like that, by varying at least some parameters for generating an early reflection over time, make it easy to reproduce a sound unlikely to impart a sense of unnaturalness on a user while reducing a computational amount.

More specifically, an acoustic processing method according to a first aspect of the present disclosure includes: obtaining (i) sound information related to a sound including a predetermined sound and (ii) metadata including information related to a space in which the predetermined sound is reproduced; performing, based on the sound information and the metadata, acoustic processing of generating a sound signal expressing a sound including an early reflection that reaches a user after a direct sound that reaches the user directly from a sound source object; and outputting an output sound signal including the sound signal. The acoustic processing includes: determining parameters for generating the early reflection, the parameters including a position, in the space, of a virtual sound source object that generates the early reflection; and generating the early reflection based on the parameters determined. The parameters include at least a parameter that varies over time according to a predetermined condition.

The orientation, sound pressure, or the like of the early reflection reaching the user varies over time, and this aspect therefore has an advantage that it is easy to reproduce a sound unlikely to impart a sense of unnaturalness on the user, while reducing the computational amount.

Additionally, in an acoustic processing method according to a second aspect of the present disclosure, in, for example, the acoustic processing method according to the first aspect, the parameter that varies over time is the position, in the space, of the virtual sound source object that generates the early reflection.

The processing for varying the position of the virtual sound source object over time, which requires a relatively small computational amount, has an advantage in that the orientation, sound pressure, or the like of the early reflection reaching the user can easily be varied over time.

Additionally, in an acoustic processing method according to a third aspect of the present disclosure, in, for example, the acoustic processing method according to the second aspect, the predetermined condition is a random number for determining the position of the virtual sound source object.

The processing for randomly varying the position of the virtual sound source object over time, which requires a relatively small computational amount, has an advantage in that the user is unlikely to feel a sense of unnaturalness with respect to the early reflection.

Additionally, in an acoustic processing method according to a fourth aspect of the present disclosure, in, for example, the acoustic processing method according to the second aspect, the predetermined condition is a trajectory in the space for determining the position of the virtual sound source object.

The processing for varying the position of the virtual sound source object along a trajectory over time, which requires a relatively small computational amount, has an advantage in that the user is unlikely to feel a sense of unnaturalness with respect to the early reflection.

Additionally, in an acoustic processing method according to a fifth aspect of the present disclosure, in, for example, the acoustic processing method according to any one of the second to fourth aspects, a range over which the position of the virtual sound source object can vary is determined according to a positional relationship between the user and the virtual sound source object.

Generating an appropriate early reflection in accordance with the positional relationship between the user and the virtual sound source object has an advantage in that it is further unlikely that the user will feel a sense of unnaturalness.

Additionally, in an acoustic processing method according to a sixth aspect of the present disclosure, in, for example, the acoustic processing method according to any one of the second to fifth aspects, a range over which the position of the virtual sound source object can vary is determined according to an acoustic characteristic of the space.

Generating an appropriate early reflection in accordance with the acoustic characteristics of the space has an advantage in that it is further unlikely that the user will feel a sense of unnaturalness.

Additionally, for example, a recording medium according to a seventh aspect of the present disclosure is a non-transitory computer-readable recording medium having recorded thereon a program for causing a computer to execute the acoustic processing method according to any one of the first to sixth aspects.

This has an advantage that the same effects as those of the above-described acoustic processing method can be achieved.

Additionally, for example, an acoustic processing system according to an eighth aspect of the present disclosure includes an obtainer, an acoustic processor, and an outputter. The obtainer obtains (i) sound information related to a sound including a predetermined sound and (ii) metadata including information related to a space in which the predetermined sound is reproduced. The acoustic processor performs, based on the sound information and the metadata, acoustic processing of generating a sound signal expressing a sound including an early reflection that reaches a user after a direct sound that reaches the user directly from a sound source object. The outputter outputs an output sound signal including the sound signal. The acoustic processor includes a parameter determiner and an early reflection generation processor. The parameter determiner determines parameters for generating the early reflection, the parameters including a position, in the space, of a virtual sound source object that generates the early reflection. The early reflection generation processor generates the early reflection based on the parameters determined. The parameters include at least a parameter that varies over time according to a predetermined condition.

This has an advantage that the same effects as those of the above-described acoustic processing method can be achieved.

Furthermore, these comprehensive or specific aspects of the present disclosure may be realized by a system, a device, a method, an integrated circuit, a computer program, or a non-transitory computer-readable recording medium such as a CD-ROM, or may be implemented by any desired combination of systems, devices, methods, integrated circuits, computer programs, and recording media.

An embodiment will be described in detail hereinafter with reference to the drawings. The following embodiment will describe a general or specific example. The numerical values, shapes, materials, constituent elements, arrangements and connection states of constituent elements, steps, orders of steps, or the like in the following embodiments are merely examples, and are not intended to limit the present disclosure. Additionally, of the constituent elements in the following embodiment, constituent elements not denoted in the independent claims will be described as optional constituent elements. Note also that the drawings are schematic diagrams, and are not necessarily exact illustrations.

Configurations that are substantially the same are given the same reference signs in the drawings, and redundant descriptions may be omitted or simplified.

### Embodiment

### 1. Overview

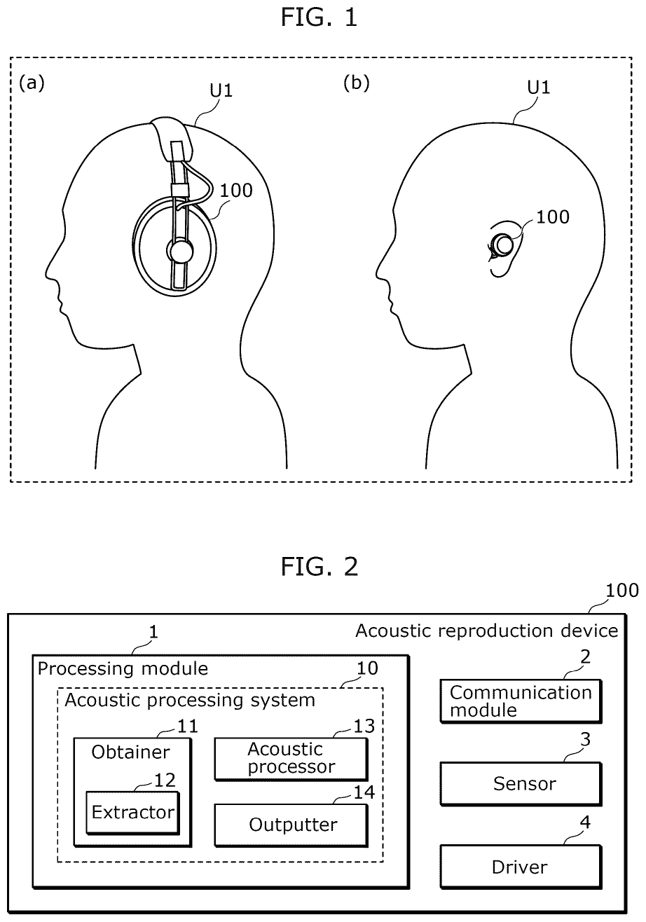

An overview of an acoustic reproduction device according to an embodiment will be described first. FIG. 1 is a schematic diagram illustrating a use case for the acoustic reproduction device according to the embodiment. (a) in FIG. 1 illustrates user U1 using one example of acoustic reproduction device 100. (b) in FIG. 1 illustrates user U1 using another example of acoustic reproduction device 100.

Acoustic reproduction device 100 illustrated in FIG. 1 is used in conjunction with, for example, a display device that displays images or a stereoscopic video reproduction device that reproduces stereoscopic video. A stereoscopic video reproduction device is an image display device worn attached on the head of user U1, and varying the images displayed in response to movement of the head of user U1 causes user U1 to feel as if they are moving their head in a three-dimensional sound field (a virtual space). In addition, the stereoscopic video reproduction device displays two images with parallax deviation between the left and right eyes of user U1. User U1 can perceive the three-dimensional position of an object in the image based on the parallax deviation between the displayed images. Although a stereoscopic video reproduction device is described here, the device may be a normal image display device, as described above.

Acoustic reproduction device 100 is a sound presentation device worn on the head of user U1. Acoustic reproduction device 100 therefore moves with the head of user U1. For example, acoustic reproduction device 100 in the embodiment may be what is known as an over-ear headphone-type device, as illustrated in (a) of FIG. 1, or may be two earplug-type devices worn separately in the left and right ears of user U1, as illustrated in (b) of FIG. 1. By communicating with each other, the two devices present sound for the right ear and sound for the left ear in a synchronized manner.

By varying the sound presented in accordance with movement of the head of user U1, acoustic reproduction device 100 causes user U1 to feel as if user U1 is moving their head in a three-dimensional sound field. Accordingly, as described above, acoustic reproduction device 100 moves the three-dimensional sound field relative to the movement of user U1 in a direction opposite from the movement of the user.

### 2. Configuration

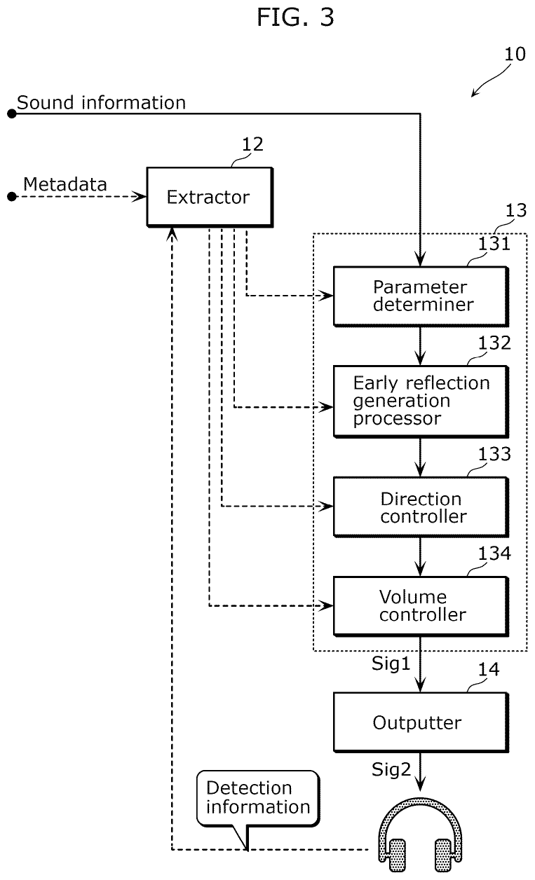

The configuration of acoustic reproduction device 100 according to the embodiment will be described next with reference to FIGS. 2 and 3. FIG. 2 is a block diagram illustrating the functional configuration of acoustic reproduction device 100 according to the embodiment. FIG. 3 is a block diagram illustrating the functional configuration of acoustic processing system 10 according to the embodiment in more detail. As illustrated in FIG. 2, acoustic reproduction device 100 according to the embodiment includes processing module 1, communication module 2, sensor 3, and driver 4.

Processing module 1 is a computing device for performing various types of signal processing in acoustic reproduction device 100. Processing module 1 includes a processor and a memory, for example, and implements various functions by using the processor to execute programs stored in the memory.

Processing module 1 functions as acoustic processing system 10 including obtainer 11, acoustic processor 13, and outputter 14, with obtainer 11 including extractor 12. Each function unit of acoustic processing system 10 will be described below in detail in conjunction with details of configurations aside from processing module 1.

Communication module 2 is an interface device for accepting the input of sound information and the input of metadata to acoustic reproduction device 100. Communication module 2 includes, for example, an antenna and a signal converter, and receives the sound information and metadata from an external device through wireless communication. More specifically, communication module 2 uses the antenna to receive a wireless signal expressing sound information converted into a format for wireless communication, and reconverts the wireless signal into the sound information using the signal converter. Through this, acoustic reproduction device 100 obtains the sound information through wireless communication from an external device. Likewise, communication module 2 uses the antenna to receive a wireless signal expressing metadata converted into a format for wireless communication, and reconverts the wireless signal into the metadata using the signal converter. Through this, acoustic reproduction device 100 obtains the metadata through wireless communication from an external device. The sound information and metadata obtained by communication module 2 are both obtained by obtainer 11 of processing module 1. Note that communication between acoustic reproduction device 100 and the external device may be performed through wired communication.

In the present embodiment, acoustic reproduction device 100 includes acoustic processing system 10, which functions as a renderer that generates sound information to which an acoustic effect is added. However, a server may handle some or all of the functions of the renderer. In other words, some or all of obtainer 11, extractor 12, acoustic processor 13, and outputter 14 may be provided in a server (not shown). In this case, the sound signal generated by acoustic processor 13 in the server, or a sound signal obtained by compositing sound signals generated by individual processors, is received and reproduced by acoustic reproduction device 100 through communication module 2.

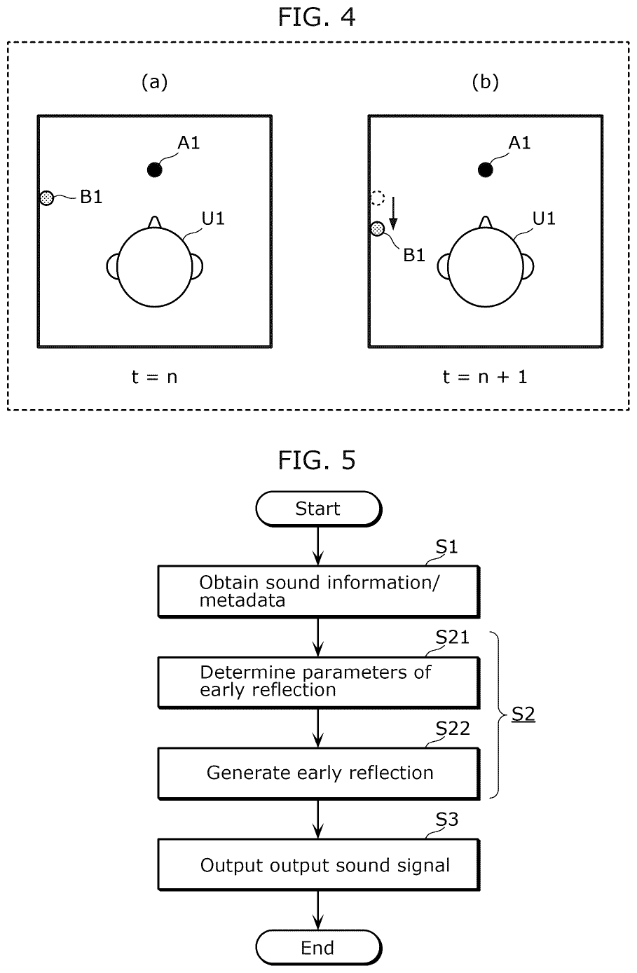

In the embodiment, the sound information and metadata are obtained by acoustic reproduction device 100 as bitstreams encoded in a predetermined format, such as MPEG-H 3D Audio (ISO/IEC 23008-3), for example. As an example, the encoded sound information includes information about a predetermined sound to be reproduced by acoustic reproduction device 100. Here, the predetermined sound is a sound emitted by sound source object A1 (see FIG. 4 and the like) present in the three-dimensional sound field or a natural environment sound, and may include, for example, the sound of a machine, the voice of a living thing including a person, and the like. Note that if a plurality of sound source objects A1 are present in the three-dimensional sound field, acoustic reproduction device 100 obtains a plurality of items of sound information corresponding to each of the plurality of sound source objects A1.

The metadata is information used in acoustic reproduction device 100 to control acoustic processing performed on the sound information, for example. The metadata may be information used to describe a scene represented in the virtual space (the three-dimensional sound field). Here, “scene” is a term referring to a collection of all elements expressing three-dimensional video and acoustic events in a virtual space, modeled by acoustic processing system 10 using the metadata. In other words, the “metadata” mentioned here may include not only information for controlling acoustic processing, but also information for controlling video processing. Of course, the metadata may include information for controlling only one of acoustic processing or video processing, or may include information used for both types of control.

Acoustic reproduction device 100 may generate a virtual acoustic effect by performing acoustic processing on the sound information using the metadata included in the bitstream and additional obtained information, such as interactive position information of user U1 and the like. Although the present embodiment describes a case where the early reflection is mainly generated as the acoustic effect, other acoustic processing may be performed using the metadata. For example, it is conceivable to add an acoustic effect such as a diffracted sound, a later reverberation sound, a distance damping effect, localization, or a Doppler effect. Additionally, information that switches some or all acoustic effects on and off may be added as metadata.

Note that some or all of the metadata may be obtained from sources other than the bitstream of the sound information. For example, the metadata controlling acoustics or the metadata controlling video may be obtained from sources other than bitstreams, or both items of the metadata may be obtained from sources other than bitstreams.

In addition, if the metadata controlling the video is included in the bitstream obtained by acoustic reproduction device 100, acoustic reproduction device 100 may be provided with a function for outputting the metadata that can be used to control the video to a display device that displays images or a stereoscopic video reproduction device that reproduces the stereoscopic video.

As an example, the encoded metadata includes (i) information about sound source object A1 that emits a sound and a three-dimensional sound field (space) including an obstacle, and (ii) information about a localization position when the sound image of the sound is localized at a predetermined position within the three-dimensional sound field (that is, is caused to be perceived as a sound arriving from a predetermined direction), i.e., information about the predetermined direction. Here, the obstacle is an object that can affect the sound perceived by user U1, for example, by blocking or reflecting the sound emitted by sound source object A1 before that sound reaches user U1. In addition to stationary objects, the obstacle can include living things, such as people, or moving objects, such as machines. If a plurality of sound source objects A1 are present in the three-dimensional sound field, for any given sound source object A1, another sound source object A1 may act as an obstacle. Sound source objects which do not produce sounds, such as building materials or inanimate objects, as well as sound source objects that emit sound, can both be obstacles.

The metadata includes information representing the shape of the three-dimensional sound field (the space), the shapes and positions of obstacles present in the three-dimensional sound field, the shape and position of sound source object A1 present in the three-dimensional sound field, and the position and orientation of user U1 in the three-dimensional sound field, respectively.

The three-dimensional sound field may be either a closed space or an open space, but will be described here as a closed space. The metadata also includes information representing the reflectance of structures that can reflect sound in the three-dimensional sound field, such as floors, walls, or ceilings, and the reflectance of obstacles present in the three-dimensional sound field. Here, the “reflectance” is a ratio of the energies of the reflected sound and incident sound, and is set for each frequency band of the sound. Of course, the reflectance may be set uniformly regardless of the frequency band of the sound. If the three-dimensional sound field is an open space, parameters set uniformly for the attenuation rate, diffracted sound, or early reflection, for example, may be used.

Although the foregoing describes reflectance as a parameter related to obstacles or sound source object A1 included in the metadata, information other than the reflectance may be included. For example, information related to the materials of objects may be included as the metadata pertaining to both the sound source object and sound source object that do not emit sounds. Specifically, the metadata may include parameters such as diffusivity, transmittance, sound absorption, or the like.

The volume, emission characteristics (directionality), reproduction conditions, the number and type of sound sources emitting sound from a single object, information specifying a sound source region in an object, and the like may be included as the information related to the sound source object. The reproduction conditions may determine, for example, whether the sound is continuously being emitted or is triggered by an event. The sound source region in the object may be determined according to a relative relationship between the position of user U1 and the position of the object, or may be determined using the object as a reference. When determined according to a relative relationship between the position of user U1 and the position of the object, user U1 can be caused to perceive sound A as being emitted from the right side of the object as seen from user U1, and sound B from the left side, based on a plane in which user U1 is viewing the object. When using the object as a reference, which sound is emitted from which region of the object can be fixed regardless of the direction in which user U1 is looking. For example, user U1 can be caused to perceive a high sound as coming from the right side of the object, and a low sound as coming from the left side of the object, when viewing the object from the front. In this case, if user U1 moves around to the rear of the object, user U1 can be caused to perceive the low sound as coming from the right side of the object, and the high sound as coming from the left side of the object, when viewing the object from the rear.

A time until the early reflection, a reverberation time, a ratio of direct sound to diffused sound, and the like can be included as the metadata related to the space. If the ratio of direct sound to diffused sound is zero, user U1 can be caused to perceive only the direct sound.

Incidentally, although information indicating the position and orientation of user U1 has been described as being included in the bitstream as metadata, information indicating the position and orientation of user U1 that changes interactively need not be included in the bitstream. In this case, information indicating the position and orientation of user U1 is obtained from information other than the bitstream. For example, position information of user U1 in a VR space may be obtained from an app that provides VR content, or the position information of user U1 for presenting sound as AR may be obtained using position information obtained by, for example, a mobile terminal estimating its own position using GPS, cameras, Laser Imaging Detection and Ranging (LiDAR), or the like.

Also, in the embodiment, of parameters for generating the early reflection, the metadata includes information indicating parameters that are varied over time (described later). Note that this information need not be included in the metadata.

Sensor 3 is a device for detecting the position or movement of the head of user U1. Sensor 3 is constituted by, for example, a gyro sensor, or a combination of one or more of various sensors used to detect movement, such as an accelerometer. In the embodiment, sensor 3 is built into acoustic reproduction device 100, but may, for example, be built into an external device, such as a stereoscopic video reproduction device that operates in accordance with the movement of the head of user U1 in the same manner as acoustic reproduction device 100. In this case, sensor 3 need not be included in acoustic reproduction device 100. Alternatively, as sensor 3, the movement of user U1 may be detected by capturing the movement of the head of user U1 using an external image capturing device or the like and processing the captured image.

Sensor 3 is, for example, fixed to a housing of acoustic reproduction device 100 as a part thereof, and senses the speed of movement of the housing. When worn on the head of user U1, acoustic reproduction device 100, which includes the stated housing, moves with the head of user U1, and thus sensor 3 can detect the speed of movement of the head of user U1 as a result.

Sensor 3 may, for example, detect an amount of rotation in at least one of three rotational axes orthogonal to each other in the three-dimensional sound field as the amount of movement of the head of user U1, or may detect an amount of displacement in at least one of the three axes as a displacement direction. Additionally, sensor 3 may detect both the amount of rotation and the amount of displacement as the amount of movement of the head of user U1.

Driver 4 includes, for example, a vibrating plate, and a driving mechanism such as a magnet, a voice coil, or the like. Driver 4 causes the driving mechanism to operate in accordance with output sound signal Sig2 output from outputter 14, and the driving mechanism causes the vibrating plate to vibrate. In this manner, driver 4 generates a sound wave using the vibration of the vibrating plate based on output sound signal Sig2, the sound wave propagates through the air or the like and reaches the ear of user U1, and user U1 perceives the sound.

Processing module 1 (acoustic processing system 10) will be described in detail hereinafter with reference to FIG. 2.

Obtainer 11 obtains the sound information and the metadata. In the embodiment, the metadata is obtained by extractor 12 in obtainer 11. Upon obtaining the encoded sound information, obtainer 11 decodes the obtained sound information and provides the decoded sound information to acoustic processor 13.

Note that the sound information and metadata may be held in a single bitstream, or may be held separately in a plurality of bitstreams. Likewise, the sound information and metadata may be held in a single file, or may be held separately in a plurality of files.

If the sound information and metadata are held separately in a plurality of bitstreams, information indicating the other associated bitstreams may be included in one of the plurality of bitstreams in which the sound information and metadata are held, or in some of the bitstreams. Alternatively, information indicating the other associated bitstreams may be included in the metadata or control information of each of the plurality of bitstreams in which the sound information and the metadata are held. If the sound information and metadata are held separately in a plurality of files, information indicating the other associated bitstreams or files may be included in one of the plurality of files in which the sound information and metadata are held, or in some of the files. Alternatively, information indicating the other associated bitstreams or files may be included in the metadata or control information of each of the plurality of bitstreams in which the sound information and the metadata are held.

Here, the associated bitstreams or files are, for example, bitstreams or files that may be used simultaneously during acoustic processing, for example. The information indicating the other associated bitstreams may be written collectively in the metadata or control information of one of the plurality of bitstreams in which the sound information and the metadata are held, or may be divided and written in the metadata or control information of at least two of the plurality of bitstreams in which the sound information and the metadata are held. Likewise, the information indicating the other associated bitstreams or files may be written collectively in the metadata or control information of one of the plurality of files in which the sound information and the metadata are held, or may be divided and written in the metadata or control information of at least two of the plurality of files in which the sound information and the metadata are held. A control file in which information indicating the other associated bitstreams or files is collectively written may be generated separately from the plurality of files in which sound information and metadata are held. At this time, the control file need not hold the sound information and metadata.

Here, the information indicating the other associated bitstreams or files is, for example, an identifier indicating the other bitstream, a filename indicating the other file, a Uniform Resource Locator (URL), a Uniform Resource Identifier (URI), or the like. In this case, obtainer 11 specifies or obtains the bitstream or file based on the information indicating the other associated bitstreams or files. The information indicating the other associated bitstreams may be included in the metadata or control information of at least some of the plurality of bitstreams in which the sound information and the metadata are held, and the information indicating the other associated files may be included in the metadata or control information of at least some of the plurality of files in which the sound information and the metadata are held. Here, the file containing information indicating the associated bitstream or file may be, for example, a control file such as a manifest file used for delivering content.

Extractor 12 decodes the encoded metadata and provides the decoded metadata to acoustic processor 13. Here, extractor 12 does not provide the same metadata to parameter determiner 131, early reflection generation processor 132, direction controller 133, and volume controller 134, which are provided in acoustic processor 13 and will be described later, but instead provides the metadata required by the corresponding functional unit to that functional unit.

In the embodiment, extractor 12 further obtains detection information including the amount of rotation, the amount of displacement, or the like detected by sensor 3. Extractor 12 determines the position and orientation of user U1 in the three-dimensional sound field (the space) based on the obtained detection information. Then, extractor 12 updates the metadata according to the determined position and orientation of user U1. Accordingly, the metadata provided by extractor 12 to each functional unit is the updated metadata.

Acoustic processor 13 performs, based on the sound information and the metadata, acoustic processing that generates sound signal Sig1 expressing a sound including an early reflection that reaches user U1 after a direct sound that reaches user U1 directly from sound source object A1. As described earlier, the early reflection is a reflected sound that reaches user U1 after at least one reflection at a relatively early stage after the direct sound from sound source object A1 reaches user U1 (e.g., several tens of ms after the time at which the direct sound arrives). In the embodiment, acoustic processor 13 includes parameter determiner 131, early reflection generation processor 132, direction controller 133, and volume controller 134, as illustrated in FIG. 3.

Parameter determiner 131 refers, for example, to the sound information and the metadata, and determines parameters for generating the early reflection, the parameters including a position, in the three-dimensional sound field (the space), of virtual sound source object B1 (see FIG. 4 and the like) that generates the early reflection. Unlike sound source object A1, virtual sound source object B1 is a virtual sound source object that does not exist in the three-dimensional sound field, is located on a virtual reflective surface, in the three-dimensional sound field, that reflects sound waves from sound source object A1, and generates sound for user U1. The sound generated by virtual sound source object B1 is the early reflection. Here, the “parameters” include the position (coordinates) of virtual sound source object B1 in the three-dimensional sound field, the sound pressure of the sound generated by virtual sound source object B1, the frequency of the sound, and the like.

In the embodiment, parameter determiner 131 varies at least some of the parameters every unit of processing time (e.g., 1/60th of a second). In other words, the parameters include at least a parameter that varies over time according to a predetermined condition. Here, parameter determiner 131 varies at least some of the parameters over time, even if the sound information and the metadata obtained every unit of processing time are the same. In other words, the variations in the parameters over time here are independent from variations caused by variations in the obtained sound information and metadata.

In the embodiment, at least some of the parameters, i.e., the parameter that varies over time, is the position of virtual sound source object B1. Specifically, the position of virtual sound source object B1 varies over time within a predetermined range based on a reference position. The reference position of virtual sound source object B1 is determined based on the relative positions of sound source object A1 and user U1. The predetermined conditions will be described in detail later in [3-2. Example 1] and [3-3. Example 2].

FIG. 4 is an explanatory diagram illustrating variations over time in the early reflection parameters. (a) in FIG. 4 illustrates the positions of sound source object A1, virtual sound source object B1, and user U1 in the three-dimensional sound field (the space) at time t=n (where n is a real number). Meanwhile, (b) in FIG. 4 illustrates the positions of sound source object A1, virtual sound source object B1, and user U1 in the three-dimensional sound field at time t=n+1. The difference between time t=n and time t=n+1 corresponds to the unit of processing time. In addition, in (a) and (b) of FIG. 4, the positions of sound source object A1 and user U1 have not varied.

As illustrated in (b) of FIG. 4, the position of virtual sound source object B1 varies from the position of virtual sound source object B1 at time t=n (see the broken line circle). Thus, in the embodiment, parameter determiner 131 determines the position of virtual sound source object B1 such that the position of virtual sound source object B1 varies over time (here, each unit of processing time).

Early reflection generation processor 132 generates the early reflection based on the parameters determined by parameter determiner 131. Specifically, early reflection generation processor 132 generates the early reflection by placing virtual sound source object B1 at the position (coordinates) in the three-dimensional sound field (the space) determined by parameter determiner 131, and causing a sound at the sound pressure and frequency determined by parameter determiner 131 to be emitted from virtual sound source object B1.

Direction controller 133 refers to the metadata and controls the direction of the early reflection that reaches user U1 from virtual sound source object B1. Specifically, based on the position of virtual sound source object B1 in the three-dimensional sound field (the space), the position of user U1, and the orientation of user U1, direction controller 133 determines the direction in which the sound emitted from virtual sound source object B1 reaches the right ear (or left ear) of user U1 from virtual sound source object B1.

Volume controller 134 refers to the metadata and controls the volume (sound pressure) of the early reflection that reaches user U1 from virtual sound source object B1. Specifically, volume controller 134 determines the volume of the early reflection when the early reflection reaches user U1, according to the distance between virtual sound source object B1 and user U1 in the three-dimensional sound field (the space). For example, volume controller 134 lowers the volume of the early reflection as the distance increases, and raises the volume of the early reflection as the distance decreases.

Outputter 14 outputs output sound signal Sig2, including sound signal Sig1 generated by acoustic processor 13, to driver 4.

### 3. Operations

Operations by acoustic processing system 10 according to the embodiment, i.e., an acoustic processing method, will be described hereinafter.

### 3-1. Basic Operations

Basic operations performed by acoustic processing system 10 according to the embodiment will be described first with reference to FIG. 5. FIG. 5 is a flowchart illustrating the basic operations performed by acoustic processing system 10 according to the embodiment. The following descriptions assume that steps S1 to S3 illustrated in FIG. 5 are repeatedly executed each unit of processing time. Note that the processing performed by direction controller 133 and the processing performed by volume controller 134 are not illustrated in FIG. 5.

First, when the operations of acoustic reproduction device 100 are started, obtainer 11 obtains the sound information and the metadata through communication module 2 (S1). Next, acoustic processor 13 starts the acoustic processing based on the obtained sound information and the metadata (S2).

In the acoustic processing, parameter determiner 131 refers to the sound information and the metadata, and determines the parameters for generating the early reflection (S21). Here, as already described, parameter determiner 131 causes at least some of the parameters for generating the early reflection to vary over time according to a predetermined condition. For example, parameter determiner 131 varies at least some of the parameters every unit of processing time. Next, in the acoustic processing, early reflection generation processor 132 generates the early reflection based on the parameters determined by parameter determiner 131 (S22).

Additionally, in the acoustic processing, direction controller 133 refers to the metadata and determines the direction of the early reflection that reaches user U1 from virtual sound source object B1. Furthermore, in the acoustic processing, volume controller 134 refers to the metadata and determines the volume (sound pressure) of the early reflection that reaches user U1 from virtual sound source object B1.

Then, outputter 14 outputs output sound signal Sig2, including sound signal Sig1 generated by acoustic processor 13 (S3).

### 3-2. Example 1

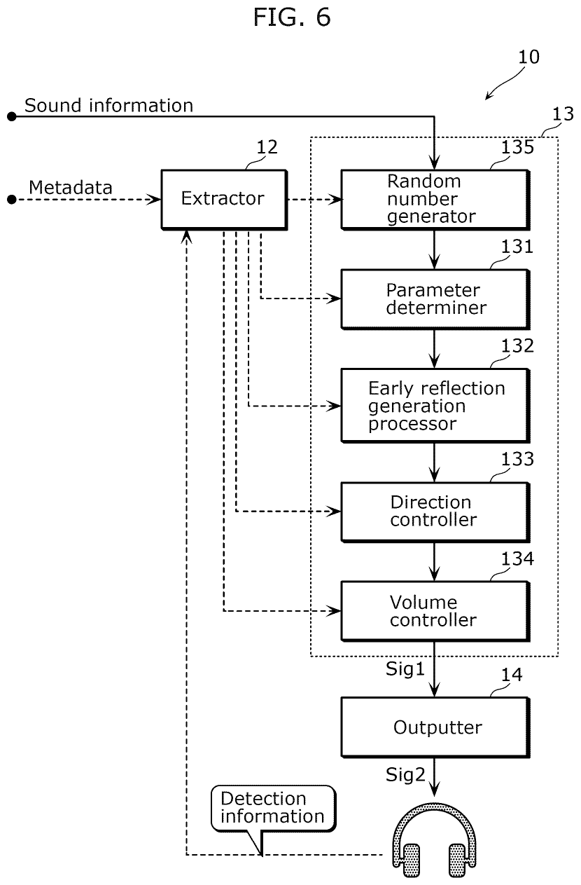

Example 1 of acoustic processing system 10 according to the embodiment will be described hereinafter with reference to FIG. 6. FIG. 6 is a block diagram illustrating the functional configuration of Example 1 of acoustic processing system 10 according to the embodiment. As illustrated in FIG. 6, in Example 1, acoustic processor 13 further includes random number generator 135.

Random number generator 135 generates a random number each unit of processing time, according to a suitable random number generation algorithm. Specifically, random number generator 135 generates random numbers “n1”, “n2”, and “n3” (“n1”, “n2”, and “n3” are all real numbers), which are added to the X, Y, and Z coordinates of virtual sound source object B1 in the three-dimensional sound field (the space), each unit of processing time. In Example 1, each of the random numbers “n1”, “n2”, and “n3” can take a range of approximately ±0.2 (the unit is “m”). In other words, the possible range of random numbers generated by random number generator 135 is not infinite, and is rather appropriately set within a range that makes it unlikely that the user will feel a sense of unnaturalness when the position of virtual sound source object B1 varies.

In Example 1, parameter determiner 131 varies the position of virtual sound source object B1 over time (here, each unit of processing time) by referring to the random number generated by random number generator 135. For example, if the reference position of virtual sound source object B1 in the three-dimensional sound field (the space) is represented by Formula (1) below, the position of virtual sound source object B1 determined with reference to the random number is represented by Formula (2) below. In Formulas (1) and (2) below, “(x, y, z)” represents the coordinates of virtual sound source object B1, and “a”, “b”, and “c” are real numbers.

$$\begin{matrix}[ Math . 1 ] & \\ ( x , y , z ) = ( a , b , c ) & ( 1 )\end{matrix}$$

$$( x , y , z ) = ( a + {n}_{1} , b + {n}_{2} , c + {n}_{3} ) \qquad ( 2 )$$

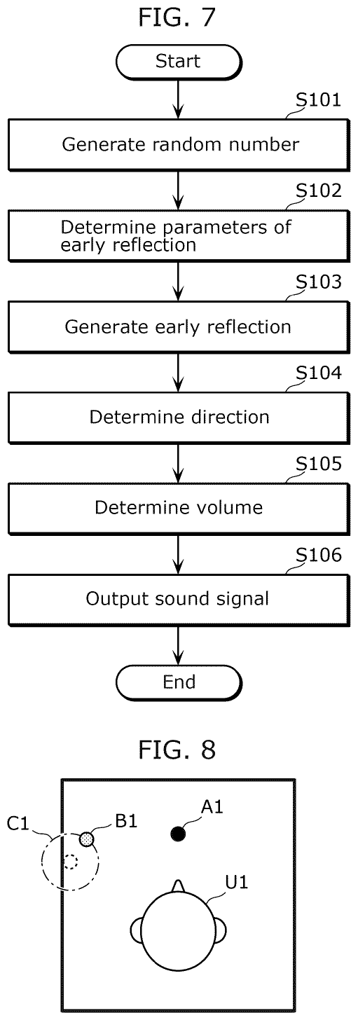

Operations performed in Example 1 of acoustic processing system 10 according to the embodiment will be described hereinafter with reference to FIG. 7. FIG. 7 is a flowchart illustrating operations performed in Example 1 of acoustic processing system 10 according to the embodiment. The operations illustrated in FIG. 7 are operations performed by acoustic processor 13. The following descriptions assume that steps S101 to S106 illustrated in FIG. 7 are repeatedly executed by acoustic processor 13 each unit of processing time.

First, random number generator 135 generates a random number (S101). Next, parameter determiner 131 refers to the sound information and the metadata, and determines the parameters for generating the early reflection (S102). Here, referring to the random number generated by random number generator 135, parameter determiner 131 determines the position of virtual sound source object B1, among the parameters for generating the early reflection. Accordingly, the position of virtual sound source object B1 will vary over time (here, each unit of processing time) according to the random number. Next, early reflection generation processor 132 generates the early reflection based on the parameters determined by parameter determiner 131 (S103).

Next, direction controller 133 refers to the metadata and determines the direction of the early reflection that reaches user U1 from virtual sound source object B1 (S104). Furthermore, volume controller 134 refers to the metadata and determines the volume (sound pressure) of the early reflection that reaches user U1 from virtual sound source object B1 (S105). Then, acoustic processor 13 outputs the generated sound signal Sig1 to outputter 14 (S106).

In this manner, in Example 1, parameter determiner 131 varies the position of virtual sound source object B1 each unit of processing time according to the random number generated by random number generator 135, based on the reference position of virtual sound source object B1. In other words, in Example 1, the predetermined condition is a random number for determining the position of virtual sound source object B1.

For example, if virtual sound source object B1 and user U1 are positioned relatively close to each other, e.g., if the distance between virtual sound source object B1 and user U1 in the three-dimensional sound field (the space) is within 1 m, the range of possible random numbers may be narrowed down. In other words, the possible range of random numbers may be varied according to the positions of virtual sound source object B1 and user U1 in the three-dimensional sound field. In other words, the range over which the position of virtual sound source object B1 can vary may be determined according to the positional relationship between user U1 and virtual sound source object B1. In this case, the possible range of random numbers is, for example, ±0.05 to ±0.2.

In addition, the possible range of random numbers may be varied according to the reflectance of obstacles (e.g., walls and the like) present in the three-dimensional sound field (the space). For example, the possible range of random numbers may be narrowed down as the reflectance of the obstacle decreases. In addition, the possible range of random numbers may be varied according to the size or shape of the three-dimensional sound field. In other words, the range over which the position of virtual sound source object B1 can vary may be determined according to the acoustic characteristics of the three-dimensional sound field (the space).

### 3-3. Example 2

Example 2 of acoustic processing system 10 according to the embodiment will be described hereinafter with reference to FIG. 8. FIG. 8 is an explanatory diagram illustrating operations performed in Example 2 of acoustic processing system 10 according to the embodiment.

In Example 2, parameter determiner 131 varies the position of virtual sound source object B1 over time (here, each unit of processing time) along a predetermined trajectory C1. Specifically, if the reference position of virtual sound source object B1 in the three-dimensional sound field (the space) is represented by Formula (1) above, the position of virtual sound source object B1 is varied to satisfy Formula (3) below. In Formula (3) below, “r” represents the radius of a sphere, and is a real number.

$$\begin{matrix}[ Math . 2 ] & \\ {( x - a )}^{2} + {( y - b )}^{2} + {( z - c )}^{2} = {r}^{2} & ( 3 )\end{matrix}$$

Accordingly, as illustrated in FIG. 8, the position of virtual sound source object B1 will vary over time (here, each unit of processing time) along the outside surface (trajectory C1) of a sphere having a radius “r” (in FIG. 8, the circle, in plan view) centered on the reference position of virtual sound source object B1 (see the broken line circle). In Example 2, the radius “r” of the sphere can take a range of approximately 0.2 or less (the unit is “m”). In other words, the possible range of trajectory C1 is not infinite, and is rather appropriately set within a range that makes it unlikely that the user will feel a sense of unnaturalness when the position of virtual sound source object B1 varies.

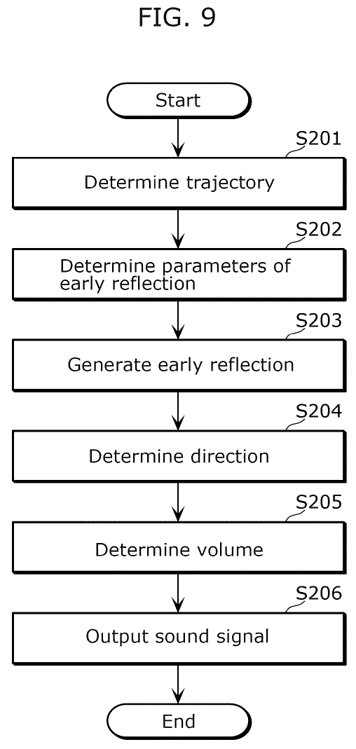

Operations performed in Example 2 of acoustic processing system 10 according to the embodiment will be described hereinafter with reference to FIG. 9. FIG. 9 is a flowchart illustrating operations performed in Example 2 of acoustic processing system 10 according to the embodiment. The operations illustrated in FIG. 9 are operations performed by acoustic processor 13. The following descriptions assume that steps S201 to S206 illustrated in FIG. 9 are repeatedly executed by acoustic processor 13 each unit of processing time.

First, parameter determiner 131 determines trajectory C1 of virtual sound source object B1 (S201). Next, parameter determiner 131 refers to the sound information and the metadata, and determines the parameters for generating the early reflection (S202). Here, referring to trajectory C1 determined in step S201, parameter determiner 131 determines the position of virtual sound source object B1, among the parameters for generating the early reflection. Accordingly, the position of virtual sound source object B1 will vary over time (here, each unit of processing time) along trajectory C1. Next, early reflection generation processor 132 generates the early reflection based on the parameters determined by parameter determiner 131 (S203).

Next, direction controller 133 refers to the metadata and determines the direction of the early reflection that reaches user U1 from virtual sound source object B1 (S204). Furthermore, volume controller 134 refers to the metadata and determines the volume (sound pressure) of the early reflection that reaches user U1 from virtual sound source object B1 (S205). Then, acoustic processor 13 outputs the generated sound signal Sig1 to outputter 14 (S206).

In this manner, in Example 2, parameter determiner 131 varies the position of virtual sound source object B1 each unit of processing time along trajectory C1, based on the reference position of virtual sound source object B1. In other words, in Example 2, the predetermined condition is trajectory C1 in the three-dimensional sound field (the space) for determining the position of virtual sound source object B1.

For example, if virtual sound source object B1 and user U1 are positioned relatively close to each other, e.g., if the distance between virtual sound source object B1 and user U1 in the three-dimensional sound field (the space) is within 1 m, the possible range of trajectory C1 may be narrowed down. In other words, the possible range of trajectory C1 may be varied according to the positions of virtual sound source object B1 and user U1 in the three-dimensional sound field. In other words, the range over which the position of virtual sound source object B1 can vary may be determined according to the positional relationship between user U1 and virtual sound source object B1. In this case, the possible range of trajectory C1 is, for example, 0.05 to 0.2.

In addition, the possible range of trajectory C1 may be varied according to the reflectance of obstacles (e.g., walls and the like) present in the three-dimensional sound field (the space). For example, possible range of trajectory C1 may be narrowed down as the reflectance of the obstacle decreases. In addition, the possible range of trajectory C1 may be varied according to the size or shape of the three-dimensional sound field. In other words, the range over which the position of virtual sound source object B1 can vary may be determined according to the acoustic characteristics of the three-dimensional sound field (the space).

The shape of trajectory C1 is not limited to a spherical shape, and may be other shapes, such as a circle or an ellipse. In other words, trajectory C1 may be a three-dimensional trajectory or a two-dimensional trajectory.

### 4. Advantages

Advantages of acoustic processing system 10 (the acoustic processing method) according to the embodiment will be described hereinafter with comparison to an acoustic processing system of a comparative example. The acoustic processing system of the comparative example differs from acoustic processing system 10 according to the embodiment in that the position of virtual sound source object B1 is fixed, and does not vary over time.

When using the acoustic processing system of the comparative example, the position of virtual sound source object B1 does not vary over time. As such, reflected sounds will continue to reach user U1 from the same direction and at the same sound pressure, which may impart a sense of unnaturalness on user U1.

In contrast, in acoustic processing system 10 (the acoustic processing method) according to the embodiment, the position of virtual sound source object B1 (i.e., the parameters for generating the early reflection) vary over time. As such, the direction and sound pressure of the reflected sound reaching user U1 also vary over time, which makes it unlikely for user U1 to feel a sense of unnaturalness. In addition, the processing for varying the position of virtual sound source object B1 over time requires less computation than processing for generating an early reflection by simulating the fluctuation of sound waves from the reflection point in the real space.

Accordingly, acoustic processing system 10 (the acoustic processing method) according to the embodiment has an advantage in that it is easy to reproduce a sound unlikely to impart a sense of unnaturalness on user U1, while also reducing the amount of computation.

### Other Embodiments

Although an embodiment has been described thus far, the present disclosure is not limited to the foregoing embodiment.

In the foregoing embodiment, with respect to the parameters that vary over time, parameter determiner 131 need not vary the parameters each unit of processing time. For example, parameter determiner 131 may vary those parameters each predetermined length of time (e.g., an integral multiple of the unit of processing time), or may vary the parameters at indefinite intervals.

In the foregoing embodiment, parameter determiner 131 may vary at least some of the parameters over time according to a predetermined condition other than a random number or trajectory C1. For example, parameter determiner 131 may vary at least some of the parameters over time according to a predetermined variation pattern.

In the foregoing embodiment, the parameter that varies over time is not limited to the position of virtual sound source object B1. For example, the parameter that varies over time may be the sound pressure of the sound generated by virtual sound source object B1, the frequency of the sound, or the like. The parameter that varies over time is not limited to one parameter, and a plurality of parameters may vary instead. For example, the parameters that vary over time may be two or more parameters including the position of virtual sound source object B1, the sound pressure of the sound generated by virtual sound source object B1, and the frequency of the sound.

In the foregoing embodiment, acoustic processor 13 may perform processing other than processing for generating the early reflection. For example, acoustic processor 13 may perform later reverberation sound generation processing that generates a later reverberation sound, diffracted sound generation processing that generates a diffracted sound, transmission processing for the sound signal, addition processing that adds an acoustic effect such as a Doppler effect to the sound signal, or the like. Here, the “later reverberation sound” is a reverberation sound that reaches the user at a relatively late stage after the early reflection reaches the user (e.g., between about 100 and 200 ms after the time at which the direct sound arrives), and reaches the user after more reflections than the number of reflections of the early reflection. The “diffracted sound” is a sound that, when there is an obstacle between the sound source object and the user, reaches the user from the sound source object having traveled around the obstacle.

In the foregoing embodiment, obtainer 11 obtains the sound information and metadata from an encoded bitstream, but the configuration is not limited thereto. For example, obtainer 11 may obtain the sound information and the metadata separately from information other than a bitstream.

Additionally, for example, the acoustic reproduction device described in the foregoing embodiment may be implemented as a single device having all of the constituent elements, or may be implemented by assigning the respective functions to a plurality of corresponding devices and having the plurality of devices operate in tandem. In the latter case, information processing devices such as smartphones, tablet terminals, PCs, or the like may be used as the devices corresponding to the processing modules.

The acoustic reproduction device of the present disclosure can be realized as an acoustic processing device that is connected to a reproduction device provided only with a driver and that only outputs a sound signal to the reproduction device. In this case, the acoustic processing device may be implemented as hardware having dedicated circuitry, or as software for causing a general-purpose processor to execute specific processing.

Additionally, processing executed by a specific processing unit in the foregoing embodiment may be executed by a different processing unit. Additionally, the order of multiple processes may be changed, and multiple processes may be executed in parallel.

Additionally, in the foregoing embodiment, the constituent elements may be implemented by executing software programs corresponding to those constituent elements. Each constituent element may be realized by a program executing unit such as a Central Processing Unit (CPU) or a processor reading out and executing a software program recorded into a recording medium such as a hard disk or semiconductor memory.

Each constituent element may be implemented by hardware. For example, each constituent element may be circuitry (or integrated circuitry). This circuitry may constitute a single overall circuit, or may be separate circuits. The circuitry may be generic circuitry, or may be dedicated circuitry.

The general or specific aspects of the present disclosure may be implemented by a device, a method, an integrated circuit, a computer program, or a computer-readable recording medium such as a CD-ROM. The general or specific aspects of the present disclosure may also be implemented by any desired combination of systems, devices, methods, integrated circuits, computer programs, and recording media.

For example, the present disclosure may be realized as an acoustic processing method executed by a computer, or as a program for causing a computer to execute the acoustic processing method. The present disclosure may be implemented as a non-transitory computer-readable recording medium in which such a program is recorded.

Additionally, embodiments achieved by one skilled in the art making various conceivable variations on the embodiment, embodiments achieved by combining constituent elements and functions from the embodiment as desired within a scope which does not depart from the spirit of the present disclosure, and the like are also included in the present disclosure.

### INDUSTRIAL APPLICABILITY

The present disclosure is useful in acoustic reproduction such as for causing a user to perceive stereoscopic sound.

1. An acoustic processing method comprising:
obtaining (i) sound information related to a sound including a predetermined sound and (ii) metadata including information related to a space in which the predetermined sound is reproduced;
performing, based on the sound information and the metadata, acoustic processing of generating a sound signal expressing a sound including an early reflection that reaches a user after a direct sound that reaches the user directly from a sound source object; and
outputting an output sound signal including the sound signal,
wherein the acoustic processing includes:
determining parameters for generating the early reflection, the parameters including a position, in the space, of a virtual sound source object that generates the early reflection; and
generating the early reflection based on the parameters determined, and
the parameters include at least a parameter that varies over time according to a predetermined condition.

2. The acoustic processing method according to claim 1,
wherein the parameter that varies over time is the position, in the space, of the virtual sound source object that generates the early reflection.

3. The acoustic processing method according to claim 2,
wherein the predetermined condition is a random number for determining the position of the virtual sound source object.

4. The acoustic processing method according to claim 2,
wherein the predetermined condition is a trajectory in the space for determining the position of the virtual sound source object.

5. The acoustic processing method according to claim 2,
wherein a range over which the position of the virtual sound source object can vary is determined according to a positional relationship between the user and the virtual sound source object.

6. The acoustic processing method according to claim 2,
wherein a range over which the position of the virtual sound source object can vary is determined according to an acoustic characteristic of the space.

7. A non-transitory computer-readable recording medium having recorded thereon a program for causing a computer to execute the acoustic processing method according to claim 1.

8. An acoustic processing system comprising:
an obtainer that obtains (i) sound information related to a sound including a predetermined sound and (ii) metadata including information related to a space in which the predetermined sound is reproduced;
an acoustic processor that performs, based on the sound information and the metadata, acoustic processing of generating a sound signal expressing a sound including an early reflection that reaches a user after a direct sound that reaches the user directly from a sound source object; and
an outputter that outputs an output sound signal including the sound signal,
wherein the acoustic processor includes:
a parameter determiner that determines parameters for generating the early reflection, the parameters including a position, in the space, of a virtual sound source object that generates the early reflection; and
an early reflection generation processor that generates the early reflection based on the parameters determined, and
the parameters include at least a parameter that varies over time according to a predetermined condition.
